(19) United States
(12) Patent Application Publication
(10) Pub. No.: US 2002/0068493 A1
(43) Pub. Date: Jun. 6, 2002

(54) Plastic deformable material web

(76) Inventors: Wilhelm Roettger, Flieden (DE); Peter Brinkmann, Limburg/Lahn (DE)

Correspondence Address: SMITH-HILL AND BEDELL, 12670 N W BARNES ROAD, SUITE 104, PORTLAND, OR, 97229

(21) Appl. No.: 09/948,426

(22) Filed: Sep. 7, 2001

(30) Foreign Application Priority Data
Sep. 8, 2000 (DE) 100 45 002.4-16

(51) Int. Cl. D03D 15/00; B32B 5/18; D03D 9/00

(52) U.S. Cl. 442/48; 442/6; 442/9; 442/13; 442/17; 442/19; 442/41

(57) ABSTRACT

Plastic deformable material web, more particularly bitumen web for use preferably in roofing applications. The material web comprises a modelling mesh as the backing material and at least one plastic deformable covering material layer such as a bitumen layer connected to the mesh. For joining the mesh (4′) to the covering material layer (2′) a thin foam web (3′) is bonded or thermally laminating to the mesh. The foam prevents detachment of the bitumen layer from the mesh due to cold flow and prevents sagging of the bitumen even at high temperatures (FIG. 2).

The invention relates to a plastic deformable material web comprising a plastic modelling mash and at least one plastic deformable covering material layer connected to the mesh.

It is, for example, in steep roofing applications that material of this kind, especially as a plastic deformable bitumen web, is required in the form of webs, sheets or strips to seal off interspaces between bitumen tiles or webs and a component such as a smoke stack, attic window, vent stack protruding from the roof surface, or also between verge, edge or the like. In flat roofing applications this applies the same for joining the fascia board as well as components such as roof lights, smoke and vents stacks protruding from the roof surface.

Such insulating webs may also be put to use in applications other than in roofing, in sealing off brought-out power, water/sewage pipe or other connections.

The requirement in these applications is to waterproof the transition from a substantially flat surface area or straight edge to a three-dimensional surface area, requiring the insulating tape to be extensible and plastically conform in both directions at the same time.

Plastic deformable bitumen webs including a mesh as a reinforcement inlay are known, for example, from DE-OS 2 225 358, U.S. Pat No. 4,219,603 or U.S. Pat. No.4,368,228. One problem associated with known bitumen webs is avoiding the flow of the bituminous compound at high temperatures, on the one hand, and its embrittlement at freezing temperatures. Apart from this, these known webs have low expandability and thus poor conformability where double-curvature surface areas are concerned.

The objective of the invention is to provide a plastic deformable material web capable of conforming to spherically curved components whilst ensuring dimensional stability even at high temperatures.

This objective is achieved in accordance with the invention by a plastic deformable material web as characterized in claim 1. Further aspects of the invention read from the sub-claims.

The invention proposes for connecting the covering material layer, such as a bitumen layer, to a mesh as a reinforcement inlay, bonding or thermally laminating a thin creped now-woven or foam web to the mesh. This material composite of mesh and creped now-woven or thin web of foam is impregnated with bitumen, wax, hot-melt adhesive, synthetic rubber or the like or coated, lacquered or impregnated with emulsions, lacquers or the like. For example, the material composite is drawn through a bath of bitumen and rolled onto a film or paper of silicone after the face has been coated with a bitumen-compatible acrylate.

Decisive for the invention is the use of the creped now-woven or thin web of foam on one or both sides of the mesh, since without this non-woven or without this foam web the bitumen, for example, would detach from the mesh due to cold flow.

For a bitumen web of enhanced plastic deformability an expanded metal mesh, preferably of aluminum of high ductility in both directions is proposed as the backing material, for example, an expanded metal mesh as set forth in DE 199 10 312,7 consisting of a network of mesh links and nodes, whereby some of the latter are configured as designed break points. The expanded metal mesh as the substrate material is first laminated with a very light open-pore polyester foam, laminating being done by brief torching with subsequent roll application, the torched foam side being fused to bond to the metal. This foam has a very high temperature resistance (approx. 200° C., temporarily as high as 270° C.) so that it is not destroyed by the subsequently applied hot bitumen (approx. 160° C.). The open-pore polyester foam has preferably a bulk density of approx. 30 kg/m³ and is approx. 1.5 cm thick for a bitumen insulating web, i.e. the foam weight is only 45 g/m² which makes for extremely low material costs.

The expanded metal mesh ensures the required dimensional stability and the foam prevents sagging of the bitumen even at high temperatures.

The present invention relates also to a verge vent comprising two side portions and a middle portion located between the two side portions. The two side portions consist of a material web in accordance with one embodiment of the present invention. The middle portion consists of a plastic modelling mesh and, applied thereto, a layer of thin creped non-woven or foam. Advantageously the corresponding layers of mesh and foam are configured continuous, i.e. in one piece, in the side portions and in the middle portion. Preferably, the sides portions feature a width of 5 to 15 cm, particularly preferred being a width between 6 and 8 cm. The middle portion is thus configured air permeable and thus permits adequate ventilation of the roof verge. The foam web in this embodiment of the present invention is configured preferably hydrophobic, resulting in the middle portion being impermeable to rain and snow.

The invention will now be detained with reference to the attached drawings in which:

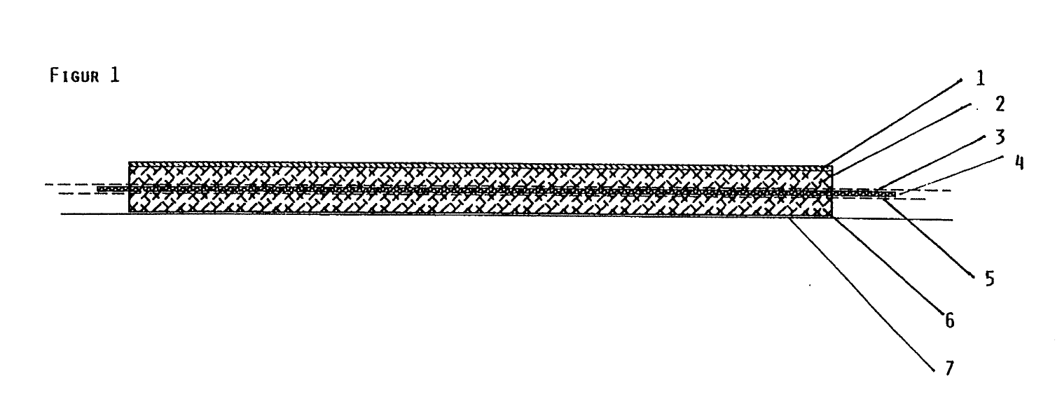

FIG. 1 is a cross-sectional view (on a magnified scale) of a plastic deformable bitumen web including a reinforcement inlay with a very thin creped non-woven applied to both sides; and

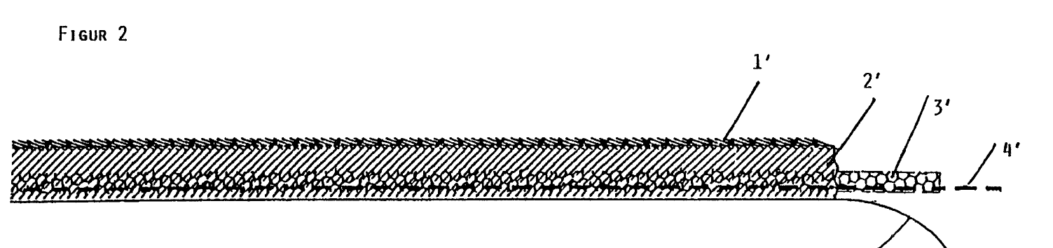

FIG. 2 is a cross-sectional view (on a magnified scale) of a plastic deformable bitumen web including a reinforcement inlay with a foam web laminated to one side.

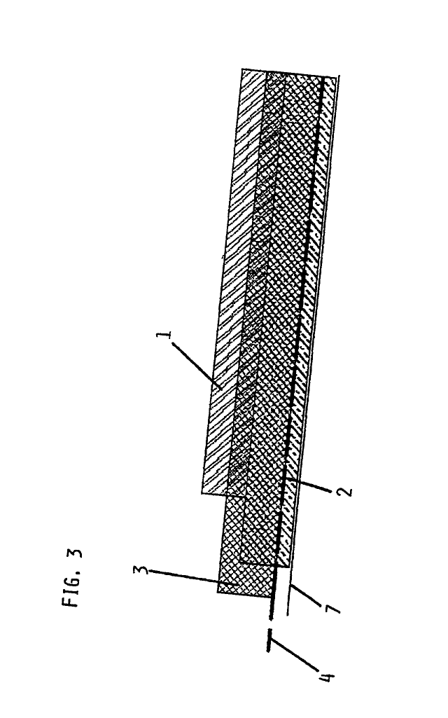

FIG. 3 is a cross-sectional view (on a magnified scale) of a plastic deformable material web with a foam web laminated to one side; and

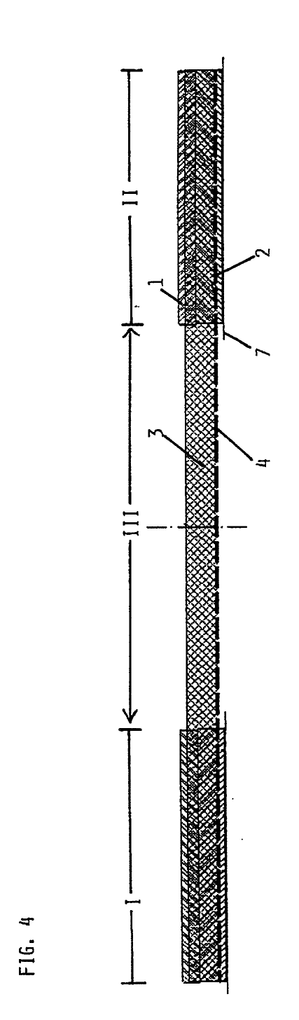

FIG. 4 is a cross-sectional view (on a magnified scale) of a verge vent comprising in the portions I and II a plastic deformable material web as shown in FIG. 3 and consisting in portion III simply of mesh and a foam web.

Referring now to FIG. 1 there is illustrated the structure of the plastic deformable bitumen web comprising from top to bottom:

a bitumen layer 2, approx. 0.7 mm thick, including a bitumen-compatible coating of acrylate 1 cancelling the surface tackiness,

a very thin, creped now-woven 3 for facilitated expansion,

an expanded metal mesh of aluminum, e.g. with designed break points at some nodes in the mesh,

a further very thin, creped now-woven 4 for facilitated expansion, and

a bitumen layer 6, the same as above, but without the coating of acrylate, and instead with a peel-off film of silicone 7 on the underside.

Using creped now-woven on both sides of the aluminum mesh ensures that the bitumen does not become detached from the aluminum mesh due to cold flow.

Referring now to FIG. 2 there is illustrated a second example embodiment of a plastic deformable bitumen web comprising a thin foam web 3′ bonded or thermally laminated to an expanded metal mesh 4′. This is followed by a bitumen layer 2′ which penetrates the foam 3′ and the expanded metal mesh 4′ at least in part, the face of which is strewn with a granulate 1′. The underside of the bitumen web is covered by a peel-off protective strip 7′.

Referring now to FIG. 3 there is illustrated a further preferred embodiment in accordance with the present invention in which a 1.0 to 1.5 mm thick foam web 3 is bonded or thermally laminated to an expanded metal mesh 4. The foam is made of polyester, polypropylene, polyurethane or similar plastics and has a density of approx. 30 kg/m3, i.e. 97% of the volume taken up by the foam consists of air. Pressed into the expanded metal mesh 4 and the foam web 3 from underneath is a plastic adhesive compound 2 of butyl rubber or hot-melt adhesive which penetrates the foam 3 and expanded metal mesh 4 at least in part. The plastic adhesive compound is covered at the underside by a peel-off protective strip 7. On the upper side the material web is covered by an extensible acrylic emulsion 1. The advantages of this embodiment lie in the fact that the foam provides firm holding of the underside adhesive compound, prevents sagging through the mesh at high temperatures whilst the foam constitutes a bonding course for the adhesive compound coating with the acrylic emulsion.

Referring now to FIG. 4 there is illustrated a verge vent in cross-section, comprising in the portions I and II a plastically deformable material web as shown in FIG. 3. In the portion III the verge vent simply comprises the mesh 4 and the foam web 3. The portion III is permeable to air to thus permit adequate ventilation of the verge. The foam web 3 is preferably formulated hydrophobic and thus resistant to rain and snow.

Instead of a bitumen layer or a plastic adhesive compound the composite of expanded metal mesh and non-woven or expanded metal mesh and foam may be covered, for example, by a hot-melt laminate in all example embodiments.

Likewise, a thermally activated layer, e.g. a hot-melt film may be applied to the underside of such webs so that the webs can also be welded or thermally joined to the base in each case.

There is furthermore the possibility of covering the backing bitumen webs with a protective film which does not need to be peeled off before laying, but may be removed by torching to thus permit accelerated laying.

1. A plastic deformable material web comprising a plastic modelling mesh (4, 4′) and at least one plastic deformable covering material layer (2, 6; 2′) connected to said mesh wherein for connecting said mesh to said covering material layer a thin creped now-woven (3, 5) or thin foam web (3′) is bonded or thermally laminated to said mesh.

2. The material web as set forth in claim 1 wherein said mesh is an expanded metal mesh (4, 4′) and preferably an expanded metal mesh of aluminum.

3. The material web as set forth in claim 2 wherein said mesh is an expanded metal mesh (4, 4′) in which some nodes are configured as designed break points.

4. The material web as set forth in any of the claims 1 to 3 wherein said thin foam web (3′) is made of polyester, polypropylene or polyurethane.

5. The material web as set forth in any of the claims 1 to 3 wherein said thin foam web (3′) is a very lightweight, open-pore polyester foam 0.5 to 5 mm, preferably 0.1 to 1.5 mm thick, having a bulk density of preferably approx. 30 kg/m³.

6. The material web as set forth in any of the claims 1 to 3 wherein a thin creped now-woven (3, 5) preferably 0.1 to 1 mm thick is bonded or thermally laminated to both sides of said mesh (4).

7. The material web as set forth in any of the claims 1 to 6 wherein said covering material layer is a layer of bitumen (2, 6; 2′).

8. The material web as set forth in claim 6 wherein the face of said bitumen layer (2, 2′) is coated with granulate (1′) or with a bitumen-compatible acrylate (1) or the like and the underside of said bitumen layer (6, 2′) is covered by a peel-off or torch-removable protective film (7, 7′) or protective coating.

9. The material web as set forth in any of the claims 1 to 6 wherein said covering material layer (2, 6; 2′) is a layer of wax, hot-melt adhesive or synthetic rubber, more particularly butyl rubber.

10. The material web as set forth in claim 7, 8 or 9 wherein said covering material layer (2, 6; 2′) penetrates said creped now-woven (3, 5) or foam web (2′) at least in part.

11. The material web as set forth in any of the claims 1 to 6 wherein said covering material layer (2, 6; 2′) is a layer of lacquer or emulsion, more particularly an acrylic emulsion layer.

12. The material web as set forth in any of the preceding claims wherein the underside of said covering material layer (6, 2′) is finished with a self-adhesive or thermally activated layer.

13. A verge vent comprising two side portions I and II and a portion III located between said portions I and II, said two side portions I and II consisting of a material web as set forth in claims 1 to 12 and said portion III consisting of a plastic modelling mesh (4) and, applied thereto, a layer of thin creped non-woven (3) or foam (3).
